(19) United States
(12) Patent Application Publication
(10) Pub. No.: US 2013/0020989 A1
(43) Pub. Date: Jan. 24, 2013

(54) AC-DC POWER CONVERTER AND DC CHARGING STATION THEREOF

(71) Applicants: Li-Tao Xia, Shanghai (CN); Tsung-Yuan Wu, Shanghai (CN); Jin-Fa Zhang, Shanghai (CN)

(72) Inventors: Li-Tao Xia, Shanghai (CN); Tsung-Yuan Wu, Shanghai (CN); Jin-Fa Zhang, Shanghai (CN)

(73) Assignee: Delta Electronics (Shanghai) Co., Ltd., Shanghai (CN)

(21) Appl. No.: 13/292,085

(22) Filed: Nov. 9, 2011

(30) Foreign Application Priority Data
Jul. 21, 2011 (CN) 201110204998.3

(51) Int. Cl. H02J 7/00; H02J 1/00; H02M 3/335

(52) U.S. Cl. 320/109; 363/17; 307/11; 320/107

(57) ABSTRACT

An AC-DC power converter is provided, and includes a phase-shifting transformer, at least one rectifier set and at least one DC-DC converter, wherein the phase-shifting transformer has a primary winding and at least one secondary winding, and the at least one secondary winding is configured as at least one winding unit; each rectifier set has at least one rectifier, and each rectifier is electrically connected with the secondary winding of a corresponding winding unit; and the DC-DC converter is electrically connected with a corresponding rectifier set and outputs a predetermined DC voltage. A DC charging station is also provided correspondingly. The phase-shifting transformer has at least one secondary winding, and the secondary windings are configured as at least one winding unit, thus providing different phase-shifting angles based on the actual number of windings in each winding unit, thereby decreasing current harmonic components and increasing the system power factor.

### RELATED APPLICATIONS

This application claims priority to Chinese Application Serial Number 201110204998.3, filed Jul. 21, 2011, which is herein incorporated by reference.

### BACKGROUND

1. Field of Invention

The present invention relates to a power electronic conversion technique. More particularly, the present invention relates to an AC-DC (Alternating Current-Direct Current) power converter with a high power factor.

2. Description of Related Art

It is known to all of us that most of current vehicles generally use petroleum as a power source. However, as petroleum is used a regular energy source, the unbalance between petroleum preservation and petroleum consumption is becoming more and more serious. It is no exaggeration to say that, based on the current consumption rate of petroleum resource, it is estimated that the petroleum resource will disappear in the near future due to resource exhaustion. Moreover, when petroleum fuel is used as a power resource, a variety of toxic gases will be discharged, and many environmental pollution problems, such as greenhouse effect, acid rain or photo-chemical smog will be caused.

With the development of science and technology and with the continuous improvement of new energy research, people gradually pay more attention on the concept of energy saving and environmental protection in daily life. Taking the traffic field as an example, with the global carbon emission reduction trend and with the highly-advocated environmental protection trend in this country, the advocacy for using electric vehicles is becoming stronger and stronger. For example, an electric vehicle and a plug-in hybrid electric vehicle both have an electromotor for providing a driving force. In general, the electric vehicle or the plug-in hybrid electric vehicle has a rechargeable battery which serves as a stable energy source for providing the driving force. If the remaining electric energy of the rechargeable battery is not sufficient, the electric energy can be restored by using corresponding charging equipment via an electric grid, so as to provide the electromotor with the energy required for converting the electric energy to kinetic energy.

Currently, a DC (direct current) vehicle charging station, i.e. a DC charging station is developed rapidly. It is noted that the DC charging station generally includes an AC-DC converter which converts alternating current (AC) into direct current (DC), wherein an AC input terminal of the AC-DC converter is often connected with an electric grid. For not affecting other users on the electric grid and decreasing pollution to the electric grid, there is a need to provide an AC-DC converter with a high power factor and low harmonic components.

In view of the above, it is an issue desired to be resolved by those skilled in the art regarding how to design a novel AC-DC power converter for increasing the system power factor and meanwhile apparently decreasing the pollution to the electric grid.

### SUMMARY

With respect to the aforementioned disadvantages of the prior art using an AC-DC power converter for providing DC voltage, the present invention provides an AC-DC power converter and a DC charging station which includes the AC-DC power converter.

According to an aspect of the present invention, an AC-DC power converter is provided, which includes:

a phase-shifting transformer having a primary winding and at least one secondary winding, wherein the at least one secondary winding is configured as at least one winding unit;

at least one rectifier set, wherein each rectifier set has at least one rectifier and is connected with a corresponding winding unit, and each rectifier of the rectifier set is electrically connected with the secondary winding of the corresponding winding unit; and

at least one DC-DC converter, wherein each DC-DC converter is electrically connected with a corresponding rectifier set and outputs a predetermined DC voltage.

Each of the winding units has at least one secondary winding, and the at least one secondary winding provides different phase-shifting angles respectively. In an embodiment, each of the winding units includes the same number of secondary windings. In another embodiment, each of the winding units includes a different number of secondary windings.

The primary winding and the secondary windings are delta connected, star connected or Zig-Zag connected with each other.

In a specific embodiment, each of the rectifier sets is formed by connecting a plurality of rectifiers in series. In another specific embodiment, each of the rectifier sets is formed by connecting a plurality of rectifiers in parallel.

The AC-DC power converter also includes an input terminal for receiving a three-phase AC signal, and the input terminal is electrically connected with the primary winding.

The AC-DC power converter has at least one DC output. In an embodiment, output terminals of the at least one DC-DC converter are connected in parallel to provide the at least one DC output. In another embodiment, output terminals of the at least one DC-DC converter are connected in series to provide the at least one DC output. In a further embodiment, a positive output terminal of a DC-DC converter in the at least one DC-DC converter is not electrically connected with other DC-DC converters, so as to provide the at least one DC output.

The DC-DC converter is an isolated full-bridge converter. In an embodiment, the full-bridge converter includes: a second filter circuit, a switching circuit, a transformer, a rectifier and a third filter, wherein the second filter circuit is electrically connected with the rectifier set for filtering a DC voltage from the rectifier set, so as to generate a second DC voltage signal; the switching circuit is electrically connected with the second filter current; the transformer has a primary winding and a secondary winding, and the primary winding is electrically connected with the switching circuit; the rectifier is electrically connected with the secondary winding of the transformer for rectifying an AC signal output from the secondary winding of the transformer, so as to generate a third DC voltage signal; and the third filter is electrically connected with the rectifier, for filtering the third DC voltage signal. The third filter further includes an inductance and a capacitance, wherein one end of the inductance is electrically connected with one output terminal of the rectifier; the other end of the inductance is electrically connected with one end of the capacitance; and the other end of the capacitance is electrically connected with the other output terminal of the rectifier. The rectifier is a full-wave rectifier, a synchronous rectifier or a current-double rectifier. The switching circuit includes at least one switching element, and the switching element is a metal oxide semiconductor field effect transistor (MOSFET) or an insulated gate bipolar transistor (IGBT).

The DC-DC converter is a non-isolated buck converter. In an embodiment, the buck converter includes: a first filter circuit, a power switch, a diode, an inductance and a capacitance, wherein the first filter circuit is electrically connected with the rectifier set, for filtering the DC voltage from the rectifier set, so as to generate a first DC voltage signal; the power switch is electrically connected with the first filter circuit; the diode is electrically connected with the power switch; the inductance is electrically connected with the cathode of the diode and the power switch; and the capacitance is electrically connected with the inductance and the anode of the diode. The power switch is a MOSFET or an IGBT.

The DC-DC converter further includes an electric current sensor electrically connected with the DC-DC converter, for outputting a current indication signal.

The DC-DC converter further includes a temperature sensor for detecting the highest temperature of the DC-DC converter in real time and outputting a temperature indication signal.

The DC-DC converter further includes a voltage sensor which is electrically connected with the output terminal of the DC-DC converter for detecting the DC voltage output from the DC-DC converter and outputting a voltage indication signal.

The AC-DC power converter further includes a control module electrically connected with at least one output terminal of the electric current sensor, the temperature sensor and the voltage sensor, and outputting a control signal according to at least one of the current indication signal, the temperature indication signal and the voltage indication signal.

The AC-DC power converter further includes a driver module which is electrically connected with the power switch and the control module for receiving the control signal and switching on or off the power switch according to the control signal.

The control module further includes a pulse width modulation unit, and the control signal is a pulse signal sent by the pulse width modulation unit.

The control module further includes a frequency modulation unit, and the control signal is a pulse signal sent by the frequency modulation unit.

The control module is an analog controller or a digital controller.

According to another aspect of the present invention, a DC charging station based on an AC-DC power conversion manner is provided, which includes:

an input terminal for receiving a three-phase AC signal;

an AC-DC power converter which is electrically connected with the input terminal for converting the three-phase AC signal to at least one DC voltage signal; and

at least one output terminal for outputting the at least one DC voltage signal so as to provide DC charging power supply to the electronic equipment desired to be charged,

wherein the AC-DC power converter is the AC-DC power converter described above according to an aspect of the present invention.

The electronic equipment includes an electric vehicle or a plug-in hybrid electric vehicle.

In the AC-DC power converter provided by the present invention, the phase-shifting transformer has at least one secondary winding, and the secondary windings are configured as at least one winding unit, thus providing different phase-shifting angles base on the actual number of windings in each winding unit, thereby decreasing current harmonic components and increasing the system power factor. Moreover, the AC-DC power converter also includes at least one rectifier set corresponding to the at least one winding unit and at least one DC-DC converter corresponding to each rectifier set, wherein the output terminals of the DC-DC converters are connected in parallel to provide a DC output, so as to increase ripple frequency in the voltage and then decrease ripple amplitude; or the output terminals of the DC-DC converters are connected in series to provide a DC output. The output terminals of different DC-DC converters can also be used to provide different DC outputs, so as to meet the demands of charging a variety of electronic equipment. Furthermore, after the at least one secondary winding is disassembled into different winding units, the DC power outputted from each DC-DC converter is greatly decreased, which can significantly decrease the requirements of parameters of the AC-DC power converter on the components in the electric circuit, thereby saving the cost. By using the AC-DC power converter provided by the present invention, the requirements of the electric grid can be met without needing to additionally design a power factor correction (PFC) circuit.

### BRIEF DESCRIPTION OF THE DRAWINGS

Aspects of the present invention can be understood more clearly by reading the following detailed description of the embodiments, with reference to the accompanying drawings as follows:

FIG. 1 is a schematic functional block diagram of an AC-DC power converter according to an aspect of the present invention;

FIG. 2 is a schematic view of an embodiment of the AC-DC power converter shown in FIG. 1;

FIG. 3 is a schematic view of another embodiment of the AC-DC power converter shown in FIG. 1;

FIG. 4 is a schematic view of an embodiment of performing circuit connection on multiple windings in the same winding unit of the AC-DC power converter of FIG. 1, the corresponding rectifiers and the DC-DC converters;

FIG. 5 is a schematic view of another embodiment of performing circuit connections on multiple windings in the same winding unit of the AC-DC power converter of FIG. 1, the corresponding rectifiers and the DC-DC converters into a circuit;

FIG. 6 illustrates a specific embodiment of the DC-DC converter in the AC-DC power converter of FIG. 1;

FIG. 7 illustrates another specific embodiment of the DC-DC converter in the AC-DC power converter of FIG. 1; and

FIG. 8 is a schematic view showing the circuit principle for controlling the parallel outputs of the multiple DC-DC converters of FIG. 2.

### DETAILED DESCRIPTION

In order to make the technical contents of the present invention more detailed and more comprehensive, various embodiments of the present invention are described below with reference to the accompanying drawings. Wherever possible, the same reference numbers are used in the drawings and the description to refer to the same or like parts. However, it should be understood by those skilled in the art that the embodiments described below are not used for limiting the scope of the present invention. Moreover, the accompanying drawings are only used for illustration and are not drawn to scale. Specific implementations in various aspects of the present invention are further described in details with reference to the accompanying drawings.

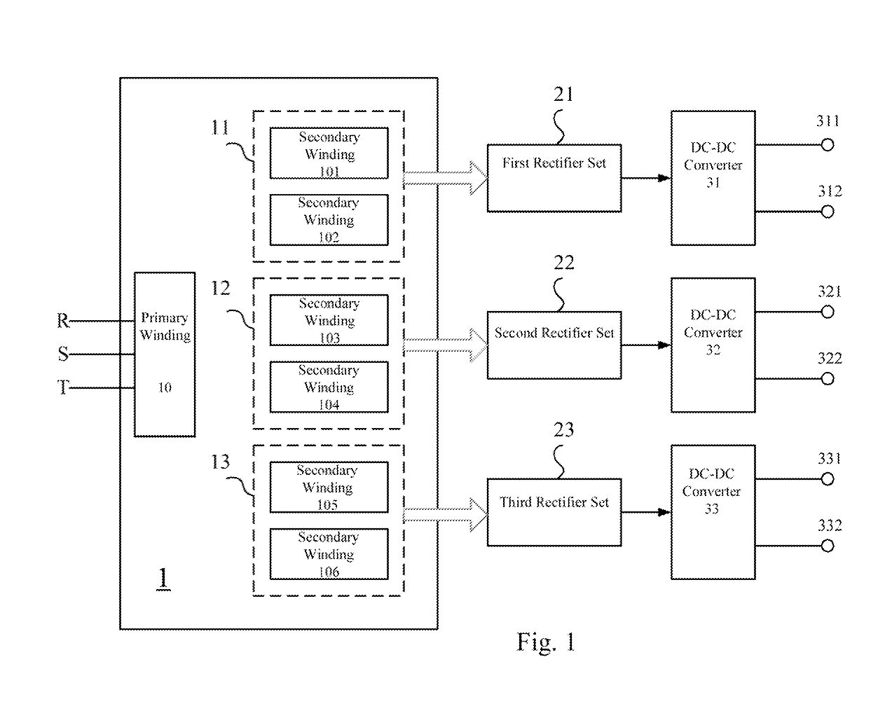

FIG. 1 is a schematic functional block diagram of an AC-DC power converter according to an aspect of the present invention. Referring to FIG. 1, in this embodiment, the AC-DC power converter includes a phase-shifting transformer 1, at least one rectifier sets (i.e. rectifier sets 21, 22 and 23) and at least one DC-DC converters (i.e. DC-DC converters 31, 32 and 33). The DC-DC converter 31 is corresponding to the first rectifier set 21, and the DC-DC converter 31 has two output terminals 311 and 312. For example, the output terminal 312 is electrically connected with a ground voltage or specific reference voltage terminal, and the output terminal 311 outputs a voltage potential relative to the output terminal 312 of the DC-DC converter 31. Similarly, the DC-DC converter 32 is corresponding to the second rectifier set 22, and the DC-DC converter 32 has two output terminals 321 and 322. For example, the output terminal 322 is electrically connected with a ground voltage or specific reference voltage terminal, and the output terminal 321 outputs a voltage potential relative to the output terminal 322 of the DC-DC converter 32. The DC-DC converter 33 is corresponding to the third rectifier set 23, and the DC-DC converter 33 has two output terminals 331 and 332. For example, the output terminal 332 is electrically connected with a ground voltage or specific reference voltage terminal, and the output terminal 331 outputs a voltage potential relative to the output terminal 332 of the DC-DC converter 33. In an embodiment, the DC-DC converter is a boost DC-DC converter. In an embodiment, the DC-DC converter is a buck DC-DC converter. In an embodiment, the DC-DC converter is an isolated DC-DC converter. In an embodiment, the DC-DC converter is a non-isolated DC-DC converter.

Specifically, the phase-shifting transformer 1 has a primary winding 10 and at least one secondary windings 101-106, and the secondary windings 101-106 are configured as at least one winding units, i.e. winding units 11, 12 and 13. In FIG. 1, the winding unit 11 has secondary windings 101 and 102; the winding unit 12 has secondary windings 103 and 104; and the winding unit 13 has secondary windings 105 and 106. In an embodiment, at least one secondary winding of each winding unit provides different phase-shifting angles respectively. For example, the phase-shifting angle provided by the secondary winding 101 of the winding unit 11 is 15 degrees, and the phase-shifting angle provided by the secondary winding 102 of the winding unit 11 is 45 degrees. Moreover, those skilled in the art should understand that the arrangement of the winding unit provided by the present invention is not limited thereto. For example, in an embodiment, one secondary winding unit is provided, and meanwhile the AC-DC power converter has one rectifier set and one DC-DC converter. In another embodiment, multiple secondary winding units are provided, for example, this embodiment has three secondary winding units. The arrangement of the secondary windings in each secondary winding unit of the present invention is not limited thereto. For example, in an embodiment, each secondary winding unit has at least one secondary winding, and any one of the secondary winding units includes the same number of secondary windings. In another embodiment, each secondary winding unit has at least one secondary winding, and any one of the secondary winding units includes different number of secondary windings.

In some specific embodiments, the primary winding and the secondary windings of the phase-shifting transformer 1 are arranged in a delta connection, a star connection or a Zig-Zag connection or a combination thereof.

In this embodiment, for the DC-DC converters 31, 32 and 33, each DC-DC converter is electrically connected with a corresponding rectifier set and outputs a predetermined DC voltage. Taking the DC-DC converter 31 as an example, when the winding unit 11 at the secondary side of the phase-shifting transformer 1 generates a voltage signal, a DC voltage is outputted after the voltage signal is rectified by the first rectifier set 21. Then, the DC voltage is inputted into the DC-DC converter 31, and the DC-DC converter 31 generates a DC output which is higher than the DC voltage (if the DC-DC converter is a boost converter) or lower than the DC voltage (if the DC-DC converter is a buck converter). In an embodiment, the AC-DC power converter further includes an input terminal. The input terminal receives a three-phase AC signal, and is electrically connected with the primary winding 10 of the phase-shifting transformer 1. Herein, the AC signal may come from any type of power supply equipment, such as an electric grid or an alternator.

Furthermore, in order to apply the AC-DC power converter of the present invention to the equipment with different capacities desired to be charged, the AC-DC power converter has at least one DC output.

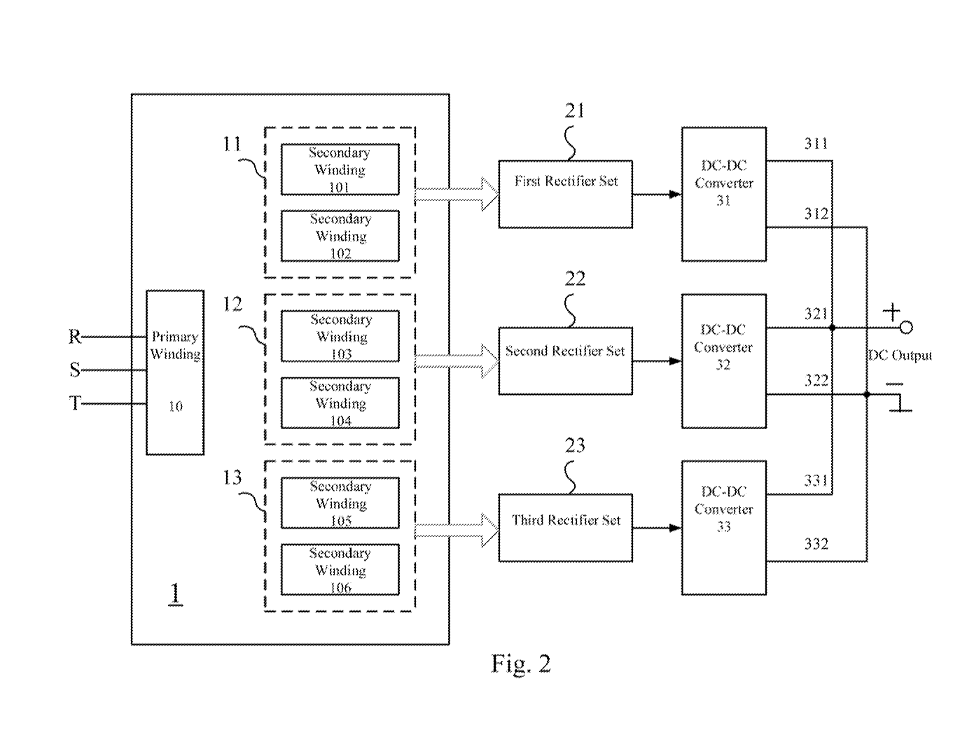

FIG. 2 is a schematic view of an embodiment of the AC-DC power converter shown in FIG. 1. In this embodiment, the output terminals 311, 321 and 331 of the DC-DC converters in the AC-DC power converter are electrically connected together, and the output terminals 312, 322 and 332 thereof are electrically connected together. That is, the outputs of the DC-DC converters 31, 32 and 33 are connected in parallel to provide at least one DC output, and such a parallel connection can significantly increase ripple frequency in the output voltage and thus decrease ripple amplitude in the output voltage, so as to greatly decrease harmonic components of the system and increase the power factor of the system. In other embodiments, the output terminals of the DC-DC converters in the AC-DC power converter are electrically connected in series to provide at least one DC output.

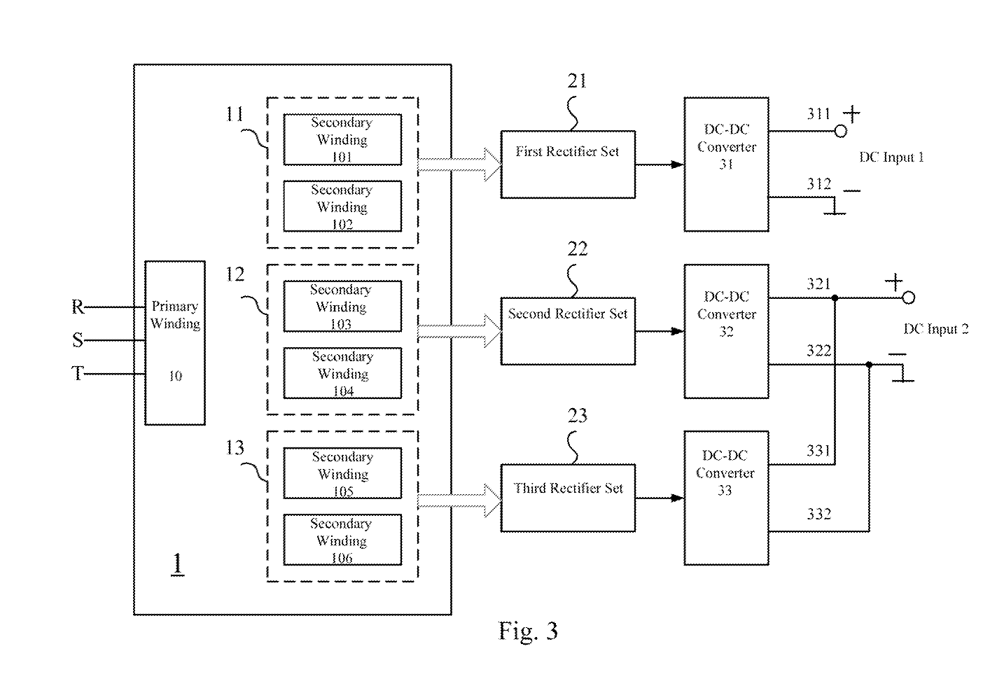

FIG. 3 is a schematic view of another embodiment of the AC-DC power converter shown in FIG. 1. In this embodiment, the outputs of the DC-DC converter 32 and the DC-DC converter 33 are connected in parallel to provide at least one DC output to the load. In other embodiments, the outputs of the DC-DC converter 32 and the DC-DC converter 33 are connected in series to provide at least one DC output to the load. The positive output terminal of the DC-DC converter 31 is not electrically connected with other DC-DC converters, so as to provide at least one DC output to the load. That is, the AC-DC power converter may adjust the number of the outputs of the DC-DC converters connected in parallel or in series according to the loading capacity demands, and can provide multiple outputs to the loads with different capacities and easily achieve modularization treatment. The modularized AC-DC power converters can achieve system miniaturization and increase the selectable space of devices in the converters, so as to reduce the system cost.

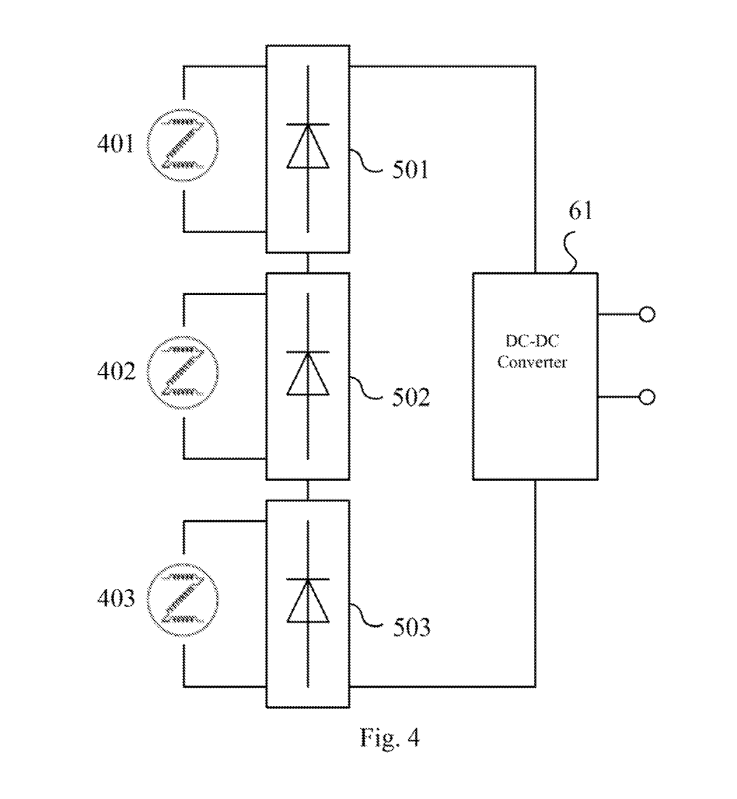

FIG. 4 is a schematic view of an embodiment of performing circuit connection on least one winding in the same winding unit of the AC-DC power converter of FIG. 1, the corresponding rectifiers and the DC-DC converters. Referring to FIG. 4, the winding unit at the secondary side of the phase-shifting transformer includes windings 401, 402 and 403. The secondary winding unit and the rectifier set corresponding to the secondary winding unit include rectifiers 501, 502 and 503, wherein the rectifier 501 is electrically connected with the winding 401; the rectifier 502 is electrically connected with the winding 402; the rectifier 503 is electrically connected with the winding 403; and two output terminals of the rectifier set formed by connecting the rectifiers 501, 502 and 503 in series are connected with the DC-DC converter 61 respectively. Thus, the DC voltage inputted into the DC-DC converter 61 is the sum of DC voltages respectively rectified by rectifiers 501, 502 and 503. In some embodiments, the number of the secondary windings and the rectifiers connected in series may be changed according to different loading capacities, so as to adjust the voltage input to the DC-DC converter 61 according to the load demand. The rectifiers 501, 502 and 503 are diode rectifiers. In an embodiment, the rectifiers 501, 502 and 503 may be other types of rectifiers.

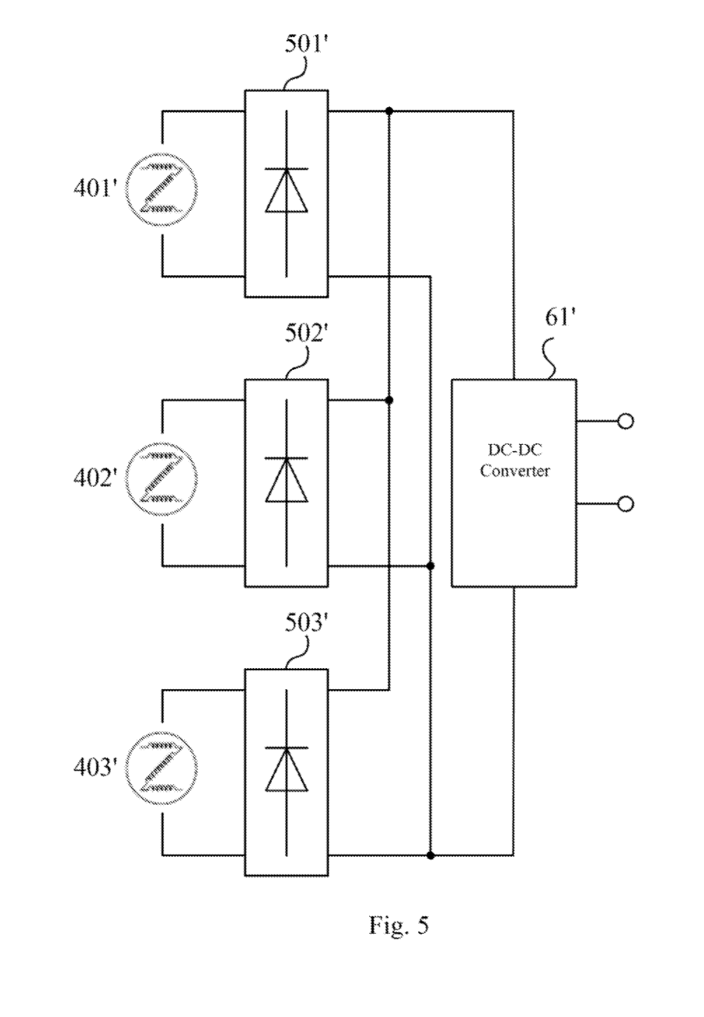

FIG. 5 is a schematic view of a second embodiment of performing circuit connection on multiple windings in the same winding unit of the AC-DC power converter of FIG. 1, the corresponding rectifiers and the DC-DC converters into a circuit. Similar to FIG. 4, the winding unit at the secondary side of the phase-shifting transformer includes windings 401′, 402′ and 403′, and the rectifier set corresponding to the winding unit includes rectifiers 501′, 502′ and 503′, wherein the rectifier 501′ is electrically connected with the winding 401′; the rectifier 502′ is electrically connected with the winding 402′; the rectifier 503′ is electrically connected with the winding 403′; and two output terminals of the rectifier set formed by connecting the rectifiers 501′, 502′ and 503′ in parallel are connected with the DC-DC converter 61′ respectively. Thus, the DC voltage input into the DC-DC converter 61′ is the sum of DC voltages respectively rectified by rectifiers 501′, 502′ and 503′. In some embodiments, the number of the secondary windings and the rectifiers connected in parallel may be changed according to different loading capacities, so as to adjust the value of the current input to the DC-DC converter 61′ according to the load demand. The rectifiers 501′, 502′ and 503′ are diode rectifiers. In an embodiment, the rectifiers 501′, 502′ and 503′ may be other types of rectifiers.

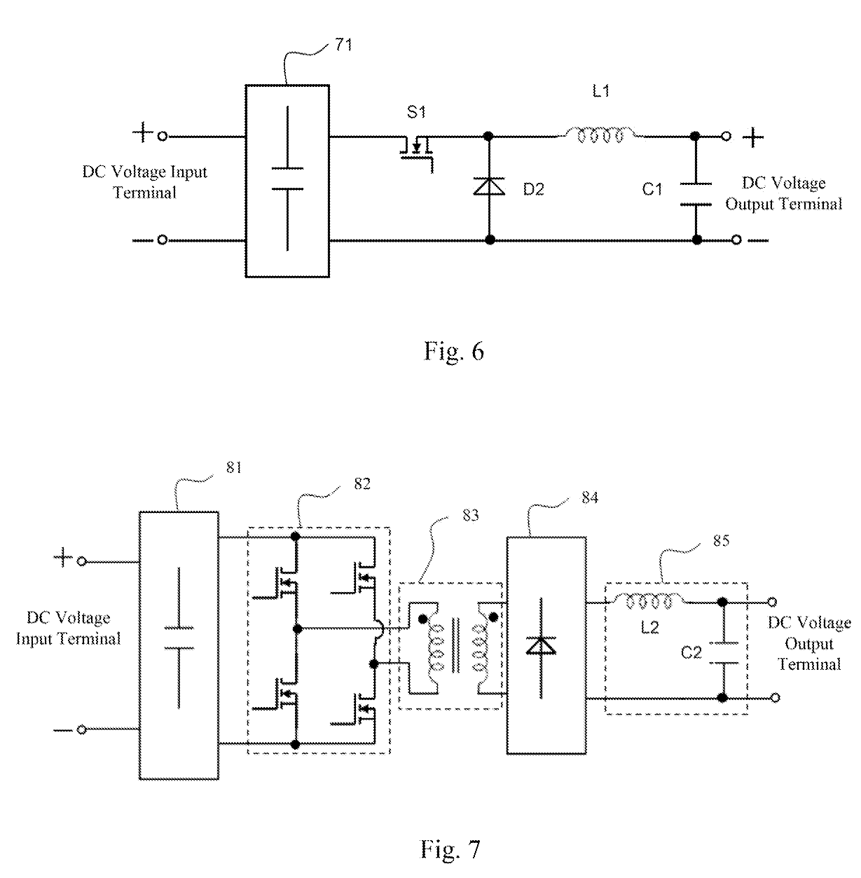

FIG. 6 illustrates a specific embodiment of the DC-DC converter in the AC-DC power converter of FIG. 1. In FIG. 6, the DC-DC converter in the AC-DC power converter of the present invention is a non-isolated buck converter. Herein, the term “non-isolated” is directed to the DC voltage input terminal and the DC voltage output terminal in the buck converter. Specifically speaking, the buck converter includes a first filter circuit 71, a power switch S1, a diode D2, an inductance L1 and a capacitance C1.

The first filter circuit 71 is electrically connected with the corresponding rectifier set for filtering the DC voltage from the rectifier set, so as to generate a first DC voltage signal. The power switch S1 is electrically connected with the first filter circuit 71, so as to connect or interrupt an electrical loop between the DC voltage input terminal and the DC voltage output terminal of the buck converter. For example, the power switch may be a metal oxide semiconductor field effect transistor (MOSFET) or an insulated gate bipolar transistor (IGBT). The cathode of the diode D2 is electrically connected with the power switch S1 and one terminal of the inductance L1. The other terminal of the inductance L1 is electrically connected with the positive output terminal of the DC voltage in the buck converter and one terminal of the capacitance C1. The other terminal of the capacitance C1 is electrically connected with the negative output terminal of the DC voltage in the buck converter and the anode of the diode D2. Those skilled in the art should understand that the electric circuit structure of the non-isolated buck converter described above is merely shown for illustration, and other electric circuit structures can also be used to implement the DC-DC converter in the AC-DC power converter of the present invention after reasonable designs.

FIG. 7 illustrates another specific embodiment of the DC-DC converter in the AC-DC power converter of FIG. 1. In FIG. 7, the DC-DC converter in the AC-DC power converter of the present invention is an isolated full-bridge converter. Herein, the term “isolated” is directed to the DC voltage input terminal and the DC voltage output terminal in the converter. That is, the DC voltage input terminal in the converter is isolated from the DC voltage output terminal through a coupling device such as a transformer. For example, the DC voltage input terminal is connected with a primary winding of the transformer, and the DC voltage output terminal is connected with a secondary winding of the transformer, so as to implement an electrical isolation between the DC voltage input terminal and the DC voltage output terminal. Specifically speaking, the full-bridge converter includes a second filter circuit 81, a switching circuit 82, a transformer 83, a rectifier 84 and a third filter 85.

The second filter circuit 81 is electrically connected with the corresponding rectifier set for filtering the DC voltage rectified by the rectifier set, so as to generate a filtered second DC voltage signal. The switching circuit 82 is electrically connected with the second filter circuit 81 and includes multiple full-bridge switching elements. For example, the switching element may be a MOSFET or an IGBT. The transformer 83 has a primary winding and a secondary winding, wherein the primary winding is electrically connected with the switching circuit 82, and the secondary winding is electrically connected with the rectifier 84. A common node between the switching elements on one bridge arm of the switching circuit 82 is electrically connected with one terminal of the primary winding of the transformer 83. A common node between the switching elements on the other bridge arm of the switching circuit 82 is electrically connected with the other terminal of the primary winding of the transformer 83. The rectifier 84 rectifies the AC voltage signal output coming from the secondary winding of the transformer 83, so as to output a DC voltage. In some embodiments, the rectifier 84 is a full-wave rectifier, a synchronous rectifier or a current-double rectifier. The third filter 85 is electrically connected with the rectifier 84 for filtering the DC voltage signal. In an embodiment, the filter further includes an inductance L2 and a capacitance C2. One terminal of the inductance L2 is electrically connected with one output terminal of the rectifier 84, and the other terminal of the inductance L2 is electrically connected with one terminal of the capacitance C2. The capacitance C2 is connected in parallel with the DC voltage output terminal of the full-bridge converter. Those skilled in the art should understand that the electric circuit structure of the isolated full-bridge converter described above is merely shown for illustration, and other electric circuit structures can also be used to implement the DC-DC converter in the AC-DC power converter of the present invention after reasonable designs.

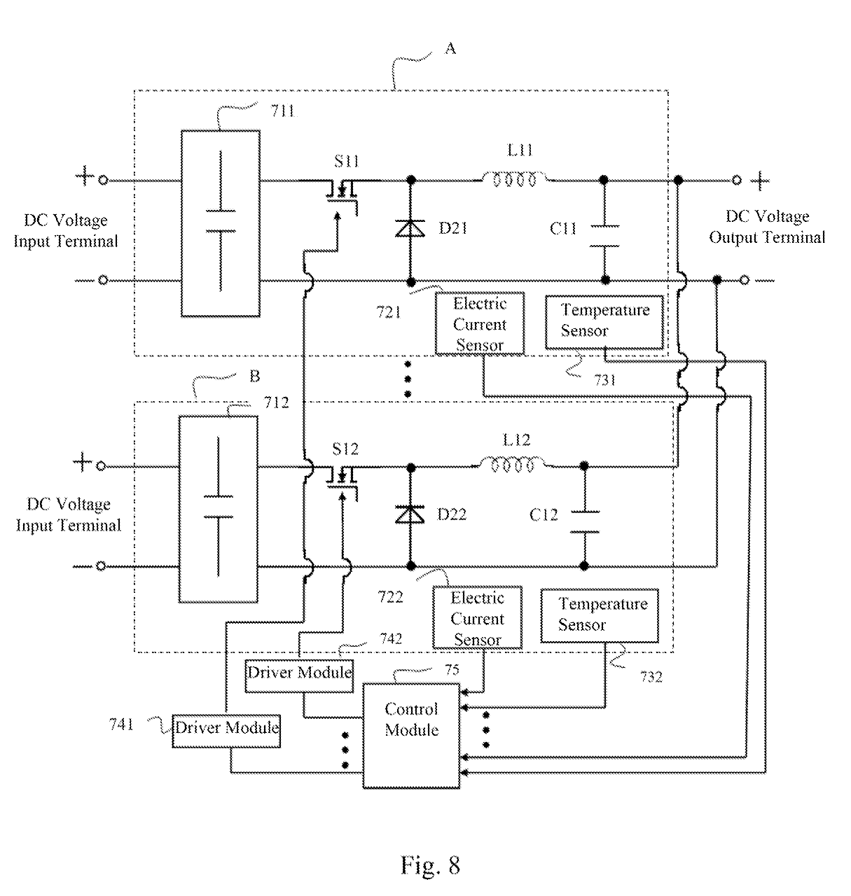

FIG. 8 is a schematic view showing the circuit principle for controlling the parallel outputs of the multiple DC-DC converters of FIG. 1. Referring to FIG. 8, the DC-DC converter A has a DC voltage input terminal and a DC voltage output terminal, and the DC-DC converter B has a DC voltage input terminal and a DC voltage output terminal, wherein the corresponding DC voltage output terminals of the DC-DC converters A and B are connected in parallel. The DC-DC converters A and B are buck converters. In this embodiment, specifically, the DC-DC converter A includes a filter circuit 711, a power switch S11, a diode D21 and a filter having an inductance L11 and a capacitance C11. The DC-DC converter B includes a filter circuit 712, a power switch S12, a diode D22 and a filter having an inductance L12 and a capacitance C12.

It is noted that FIG. 8 merely schematically illustrates a case in which a control module 75 is used for controlling two DC-DC converters, and the present invention is not limited thereto. For example, the control module 75 can control two or more DC-DC converters connected in parallel, and the control module 75 can also control a single DC-DC converter. The control module 7 controls the power switch in the DC-DC converter to perform a′ switching action of switching-on and -off by receiving parameters such as the current, voltage and/or temperature in each DC-DC converter, so as to output a predetermined output voltage and ensure normal operation of the DC-DC converter.

In a specific embodiment of the present invention, the DC-DC converter A further includes an electric current sensor 721 which is electrically connected between the filter circuit 711 and the power switch S11 for detecting the current passing through the power switch S11 and outputting a current indication signal such as an over-current signal. Similarly, the DC-DC converter B further includes an electric current sensor 722 which is electrically connected between the filter circuit 712 and the power switch S12 for detecting the current passing through the power switch S12 and outputting a current indication signal, such as an over-current signal. In another embodiment, the electric current sensor 721 is electrically connected between the anode of the diode D21 and the capacitance C11, and the electric current sensor 722 is electrically connected between the anode of the diode D22 and the capacitance C12.

In another specific embodiment of the present invention, the DC-DC converter A further includes a temperature sensor 731 which is placed on the surface of the power switch S11 or near the power switch S11 for detecting the highest temperature of the DC-DC converter A in real time and outputting a temperature indication signal, such as a signal indicating that the temperature is too high. Similarly, the DC-DC converter B further includes a temperature sensor 732 which is placed on the surface of the power switch S12 or near the power switch S12 for detecting the highest temperature of the DC-DC converter B in real time and outputting a temperature indication signal, such as a signal indicating that the temperature is too high. Herein, the switching frequency of the power switch in the DC-DC converter is high. When the power switch is frequently switched on and off, the temperature is increased relatively rapidly, so that the temperature near the power switch is substantially the highest temperature of the DC-DC converter. In other embodiments, the temperature sensor can also be placed at another position the DC-DC converter which has a relatively high temperature, so as to detect the highest temperature of the DC-DC converter timely.

In a further specific embodiment of the present invention, the DC-DC converter A (or B) further includes a voltage sensor (not shown) which is electrically connected with the DC voltage output terminal of the DC-DC converter A (or B) for detecting the DC voltage outputted from the DC-DC converter A (or B) and outputting a voltage indication signal.

In an embodiment, the AC-DC power converter of the present invention further includes a control module 75, such as an analog controller or a digital controller, which is electrically connected with the output terminal of at least one of the electric current sensors 721 and 722, the temperature sensors 731 and 732 and the voltage sensor, and outputs a control signal of the power switch of the DC-DC converter according to at least one of the corresponding current indication signal, temperature indication signal and voltage indication signal. In an embodiment, the AC-DC power converter further includes a driver module, i.e. the driver module 741 and the driver module 742 corresponding to the DC-DC converters A and B respectively. Specifically speaking, the driver module 741 is electrically connected with the power switch S11 of the DC-DC converter A and the control module 75 for receiving a control signal output from the control module 75 and controlling the power switch S11 to be on or off according to the control signal. The driver module 742 is electrically connected with the power switch S12 of the DC-DC converter B and the control module 75 for receiving a control signal output from the control module 75 and controlling the power switch S12 to be on or off according to the control signal. For example, the control module 75 further includes a pulse width modulation unit (not shown), and the control signal is a pulse signal issued by the pulse width modulation unit.

In another embodiment, the control module 75 further includes a frequency modulation unit (not shown), and the control signal is a pulse signal issued by the frequency modulation unit.

As mentioned above, the AC-DC power converter of the present invention is described in details through multiple embodiments. Furthermore, the present invention also discloses a DC charging station based on an AC-DC power conversion manner. The DC charging station includes an input terminal, an AC-DC power converter and at least one output terminal. The input terminal receives a three-phase AC signal, and then the AC-DC power converter converts the received AC signal into at least one DC output signal and sends the DC output signal to the at least one output terminal, so as to provide DC outputs with different capacities, thereby providing DC charging power supply for the electronic equipment with different capacities to be charged. For example, the electronic equipment includes an electric vehicle or a plug-in hybrid electric vehicle. It is noted that the AC-DC power converter is described in detail in the aforementioned FIGS. 1, 2 and 3, and will not be described again herein.

In the AC-DC power converter provided by the present invention, the phase-shifting transformer has at least one secondary windings, and the secondary windings are configured as at least one winding unit, so that different phase-shifting angles may be provided according to the actual number of windings of each winding unit, so as to decrease harmonic components in the current and increase the power factor of the system. Moreover, the AC-DC power converter also includes at least one rectifier set corresponding to the at least one winding unit and at least one DC-DC converter corresponding to each rectifier set, wherein the output terminals of the DC-DC converters are connected in parallel to provide a DC output, so as to increase ripple frequency in the voltage and then decrease ripple amplitude, or the output terminals of the DC-DC converters are connected in series to provide a DC output. The output terminals of different DC-DC converters can also be used to provide different DC outputs, so as to meet the demands of charging a variety of electronic equipment. Moreover, after the at least one secondary winding is disassembled into different winding units, the DC power output from each DC-DC converter is greatly decreased, which can significantly decrease the requirements of parameters of the AC-DC power converter to the components in the electric circuit, thereby saving the cost. By using the AC-DC power converter provided by the present invention, the requirements of the electric grid may be met without needing to additionally design a power factor correction (PFC) circuit.

Hereinabove, specific embodiments of the present invention are described with reference to the accompanying drawings. However, those skilled in the art should understand that various modifications and variations can be made to the specific embodiments of the present invention without departing from the spirit or scope of the present invention. Those modifications and variations all fall in the scope limited by the claims of the present invention.

What is claimed is:

1. An AC-DC power converter, comprising:
a phase-shifting transformer having a primary winding and at least one secondary winding, wherein the at least one secondary winding is configured as at least one winding unit;
at least one rectifier set, wherein each rectifier set has at least one rectifier and is connected with a corresponding winding unit, and each rectifier of the rectifier set is electrically connected with the secondary winding of the corresponding winding unit; and
at least one DC-DC converter, wherein each DC-DC converter is electrically connected with a corresponding rectifier set and outputs a predetermined DC voltage.

2. The AC-DC power converter of claim 1, wherein each winding unit has at least one secondary winding; and the at least one secondary winding provides different phase-shifting angles respectively.

3. The AC-DC power converter of claim 2, wherein each winding unit comprises the same number of secondary windings.

4. The AC-DC power converter of claim 2, wherein each winding unit comprises a different number of secondary windings.

5. The AC-DC power converter of any of claims 1-4, wherein the primary winding and the at least one secondary winding are delta connected, star connected or Zig-Zag connected with each other.

6. The AC-DC power converter of claim 1, wherein each rectifier set is formed by connecting multiple rectifiers in series.

7. The AC-DC power converter of claim 1, wherein each rectifier set is formed by connecting multiple rectifiers in parallel.

8. The AC-DC power converter of claim 1, wherein the AC-DC power converter further comprises an input terminal for receiving a three-phase AC signal, and the input terminal is electrically connected with the primary winding.

9. The AC-DC power converter of claim 1, wherein the AC-DC power converter has at least one DC output.

10. The AC-DC power converter of claim 9, wherein output terminals of the at least one DC-DC converter are connected in parallel to provide the at least one DC output.

11. The AC-DC power converter of claim 9, wherein output terminals of the at least one DC-DC converter are connected in series to provide the at least one DC output.

12. The AC-DC power converter of claim 9, wherein a positive output terminal of one DC-DC converter in the at least one DC-DC converter is not electrically connected with other DC-DC converters, so as to provide the at least one DC output.

13. The AC-DC power converter of claim 1, wherein the DC-DC converter is an isolated full-bridge converter.

14. The AC-DC power converter of claim 13, wherein the full-bridge converter comprises:
a second filter circuit which is electrically connected with the rectifier set for filtering a DC voltage coming from the rectifier set, so as to generate a second DC voltage signal;
a switching circuit electrically connected with the second filter circuit;
a transformer having a primary winding and a secondary winding, wherein the primary winding is electrically connected with the switching circuit;
a rectifier which is electrically connected with the secondary winding of the transformer for rectifying an AC signal outputted from the secondary winding of the transformer, so as to generate a third DC voltage signal; and
a third filter which is electrically connected with the rectifier for filtering the third DC voltage signal.

15. The AC-DC power converter of claim 14, wherein the third filter further comprises an inductance and a capacitance; one end of the inductance is electrically connected with one output terminal of the rectifier; the other end of the inductance is electrically connected with one end of the capacitance; and the other end of the capacitance is electrically connected with the other output terminal of the rectifier.

16. The AC-DC power converter of claim 14 or claim 15, wherein the rectifier is a full-wave rectifier, a synchronous rectifier or a current-double rectifier.

17. The AC-DC power converter of claim 14, wherein the switching circuit comprises at least one switching element which is a metal oxide semiconductor field effect transistor (MOSFET) or an insulated gate bipolar transistor (IGBT).

18. The AC-DC power converter of claim 1, wherein the DC-DC converter is a non-isolated buck converter.

19. The AC-DC power converter of claim 18, wherein the buck converter comprises:
a first filter circuit which is electrically connected with the rectifier set for filtering a DC voltage coming from the rectifier set, so as to generate a first DC voltage signal;
a power switch electrically connected with the first filter current;
a diode electrically connected with the power switch;
an inductance electrically connected with the power switch and the cathode of the diode; and
a capacitance electrically connected with the inductance and the anode of the diode.

20. The AC-DC power converter of claim 19, wherein the power switch is a metal oxide semiconductor field effect transistor (MOSFET) or an insulated gate bipolar transistor (IGBT).

21. The AC-DC power converter of claim 19, wherein the DC-DC converter also comprises an electric current sensor electrically connected with the DC-DC converter, for outputting a current indication signal.

22. The AC-DC power converter of claim 19, wherein the DC-DC converter further comprises a temperature sensor for detecting the highest temperature of the DC-DC converter in real time and outputting a temperature indication signal.

23. The AC-DC power converter of claim 19, wherein the DC-DC converter further comprises a voltage sensor which is electrically connected with the output terminal of the DC-DC converter for detecting the DC voltage output from the DC-DC converter and outputting a voltage indication signal.

24. The AC-DC power converter of any of claims 21-23, wherein the AC-DC power converter further comprises a control module which is electrically connected with at least one output terminal of the electric current sensor, the temperature sensor and the voltage sensor, and outputs a control signal according to at least one of the current indication signal, the temperature indication signal and the voltage indication signal.

25. The AC-DC power converter of claim 24, wherein the AC-DC power converter further comprises a driver module which is electrically connected with the power switch and the control module for receiving the control signal and switching on or off the power switch to according to the control signal.

26. The AC-DC power converter of claim 25, wherein the control module further comprises a pulse width modulation unit, and the control signal is a pulse signal issued by the pulse width modulation unit.

27. The AC-DC power converter of claim 25, wherein the control module further comprises a frequency modulation unit, and the control signal is a pulse signal issued by the frequency modulation unit.

28. The AC-DC power converter of claim 24, wherein the control module is an analog controller or a digital controller.

29. A DC charging station based on an AC-DC power conversion manner, the DC charging station comprising:
an input terminal for receiving a three-phase AC signal;
an AC-DC power converter of claim 1, wherein the AC-DC power converter is electrically connected with the input terminal for converting the three-phase AC signal to at least one DC voltage signal; and
at least one output terminal for outputting the at least one DC voltage signal so as to provide DC charging power supply to the electronic equipment desired to be charged.

30. The DC charging station of claim 29, wherein the electronic equipment comprises an electric vehicle or a plug-in hybrid electric vehicle.
